(19) United States
(12) Patent Application Publication
(10) Pub. No.: US 2015/0056836 A1
(43) Pub. Date: Feb. 26, 2015

(54) Arrangement For Facilitated Connection Or Separation Of A Connector And A Mating Connector

(71) Applicant: Tyco Electronics AMP GmbH, Bensheim (DE)

(72) Inventors: Georg Puckel, Obertshausen (DE); Konrad Helmut Roth, Fraenkisch-Crumbach (DE); Guenther Mumper, Egelsbach (DE)

(73) Assignee: Tyco Electronics AMP GmbH, Bensheim (DE)

(21) Appl. No.: 14/466,373

(22) Filed: Aug. 22, 2014

(30) Foreign Application Priority Data
Aug. 23, 2013 (DE) 10 2013 216 829.2

(51) Int. Cl. H01R 13/629

(52) U.S. Cl. CPC H01R 13/629
USPC 439/259

(57) ABSTRACT

An arrangement for a connector and a mating connector is provided. The arrangement includes a housing, an actuator, a connector receiving chamber, and an action mechanism. The is positioned along a surface of the housing. The connector receiving chamber is surrounded by the housing and the actuator. The action mechanism includes a drive connected to the actuator to move the actuator along the surface of the housing.

### CROSS-REFERENCE TO RELATED APPLICATIONS

This application claims the benefit of the filing date under 35 U.S.C. §119(a)-(d) of German Patent Application no. DE 10 2013 216 829.2 filed on Aug. 23, 2013.

### FIELD OF THE INVENTION

The present invention relates to an arrangement and, more particularly, to an arrangement for an electrical connector and a mating connector.

### BACKGROUND

Known connectors and mating connectors generally have a large number of individual contacts, which generally require significant contact forces to connect the known connector to the known mating connector. As a result, the forces necessary to connect the known connector to the known mating connector may too high to be performed manually during an assembly operation. This is particularly the case when regions which are difficult to access are involved, such as, for example, machine housings or engine compartments of motor vehicles. If a connector and the mating connector thereof are joined together using significant force, there is further the risk that the force which is applied may lead to damage of the contacts if both elements are not connected to each other correctly.

A series of lever-like plug type connectors are known for use to enable secure connection or separation of a contact element to/from the counter-contact element thereof. For example, EP 1 069 653 A1 discloses a lever on one of two housings, the lever having a track which can receive a counter-piece of the second housing so that, when the lever is rotated, both housings move one inside the other and are connected to each other. However, a disadvantage of such lever-like plug type connectors is that the region over which the lever travels during the rotation can no longer be used for an electrical cable which leads away from the contact element, since the wire would otherwise be in the way of the lever. Another disadvantage of the known lever-like plug type connectors is that simultaneous pressing together of the two housings and a rotation of the lever can be carried out only with difficulty since both hands are required for this. Furthermore, the lever travels transversely relative to the connection direction over one of the housing halves, the fingers being required to engage around during the connection operation.

### SUMMARY

An object of the invention, among others, is therefore to provide an arrangement for a connector and a mating connector that enables simple and reliable operation.

The arrangement includes a housing, an actuator, a connector receiving chamber, and an action mechanism. The is positioned along a surface of the housing. The connector receiving chamber is surrounded by the housing and the actuator. The action mechanism includes a drive connected to the actuator to move the actuator along the surface of the housing.

### BRIEF DESCRIPTION OF THE DRAWINGS

The invention will be explained in detail with reference to embodiments, referring to the appended drawings, in which:

FIG. 1 is a perspective view of an arrangement according to the invention;

FIG. 2 is a cross-sectional view of the arrangement shown in FIG. 1;

FIG. 3 is another perspective view of the arrangement from FIG. 1;

FIG. 4 is a perspective view of another arrangement according to the invention;

FIG. 5 is a cross-sectional view of the arrangement shown in FIG. 4; and

FIG. 6 is another perspective view of the arrangement shown in FIG. 4.

### DETAILED DESCRIPTION OF THE EMBODIMENT(S)

The invention will now be explained in greater detail below by way of exemplary embodiments shown in the referenced drawings.

With reference to FIG. 1, an arrangement 1 according to the invention is shown before mating with a connector 9 connects with a mating connector 11 and designated in the Figures as pre-contact position V. The arrangement 1 includes an actuator 3, a housing 5 and two opposing pairs of action mechanisms 7, 8 (7a, 7b and 8a, 8b). The structure and function of the arrangement 1 is described with reference to the action mechanism pair 7 for the sake of clarity and applies accordingly to the opposing action mechanism pair 8. The housing 5 and actuator 3 surround the connector receiving chamber 4. The connector receiving chamber 4 is substantially parallelepiped shaped in he shown embodiment. The action mechanisms 7, 8 are arranged outside the connector receiving chamber 4 and are positioned adjacent thereto.

As shown in FIG. 1, the arrangement 1 includes an connector 9 and a mating connector 11. The connector 9 is arranged within the connector receiving chamber 4. The mating connector 11 protrudes counter to the actuation direction B and into the connector receiving chamber 4. The actuator 3 can be displaced in the actuation direction B. It is partially inserted into the housing 5. For actuation, the actuator 3 has two gripping wings 13. In order to securely guide the actuator 3 in the actuation direction B, the actuator 3 includes guiding members 15. The guiding members 15 are inserted into guiding slots 17 of the housing. The guiding slots 17 extend parallel with the actuation direction B so that the guiding members 15 are guided by the guiding slots 17 parallel with the actuation direction B.

The actuator 3 has a cable receiving passageway 19 through which an electrical cable (not shown) can be guided. The cable receiving passageway 19 opens the connector receiving chamber 4 counter to the actuation direction B. In the pre-contact position V, a member 21 of the actuator 3 partially protrudes into the housing 5. The actuator 3 has slotted members 23, 23′ which extend transversely relative to the actuation direction B. Each two slotted members 23, 23′ which are arranged beside each other in a line and correspond to an action mechanism pair 7. The slotted members 23, 23′ are covered by the side wall 25 of the housing 5 so that they are located in a protected state within the housing 5. Sliding blocks 27, 27′ of the action mechanism pair 7 are arranged so as to protrude through the slotted members 23, 23′. The sliding blocks 27, 27′ form the drives 12 for the action mechanisms 7a, 7b.

During assembly of an arrangement 1 according to the invention, the slotted members 23, 23′ may includes insertion openings 29, 29′ by which the sliding blocks 27, 27′ can be guided during assembly. In order to prevent the sliding blocks 27, 27′ from slipping out of the slotted members 23, 23′, the sliding blocks 27, 27′ have guiding grooves 31, 31′. The sliding blocks 27, 27′ are transverse relative to the actuation direction B within the guiding grooves 31, 31′.

The sliding blocks 27, 27′ are arranged at the distal ends 28, 28′ of lever arms 33, 33′ of the tilting levers 35, 35′. The tilting levers 35, 35′ belong to the action mechanism pair 7. They are constructed to symmetrically mirror each other and therefore have lever arms 33, 33′ having identical length. The tilting levers 35, 35′ are supported by pivot members 37, 37′ which are formed by means of axial projections 39, 39′. The pivot members 37, 37′ are located in the actuation direction B at the same height. The axial projections 39, 39′ are formed integrally with the housing 5 and are therefore fixed with respect to the housing 5. The axial projections 39, 39′ protrude into axial openings 41, 41′ of the tilting levers 35, 35′. The tilting levers 35, 35′ are thereby supported on the housing 5 such that they can rotate about the pivot members 37, 37′.

At the load ends 43, 43′ thereof directed towards the pivot members 37, 37′, the tilting levers 35, 35′ have the output heads 45, 45′. The output heads 45, 45′ each have two drive teeth 47a, 47a′ and 47b, 47b′. The drive teeth 47a, 47a′, 47b, 47b′ form the proximal ends 30, 30′ of the tilting levers 35, 35′ and constitute load arms of the tilting levers 35, 35′ and the outputs 14 of the action mechanisms 7a, 7b. They displace an inserted mating connector 11. The tilting levers 35, 35′ are arranged along the inner side 49 of a side wall 25. This enables the tilting levers 35, 35′ or the action mechanism pair 7 to be protected from external influences by the side wall 25.

The lever arms 33, 33′ are arranged in a crossed manner and extend diagonally along the side wall 25. The lever arms 33, 33′ are arranged in such a manner that they do not protrude further into the housing 5 than the output heads 45, 45′. The action mechanism pair 7 is located between the side wall 25 at one side and the connector receiving chamber 4 at the other side. This enables a particularly compact construction.

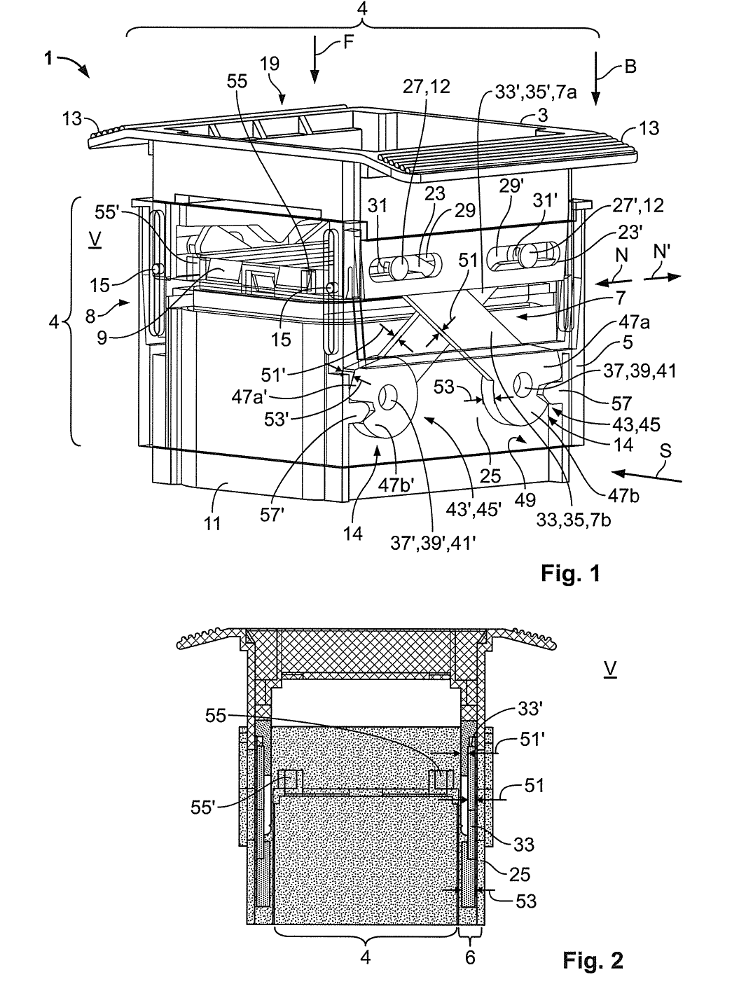

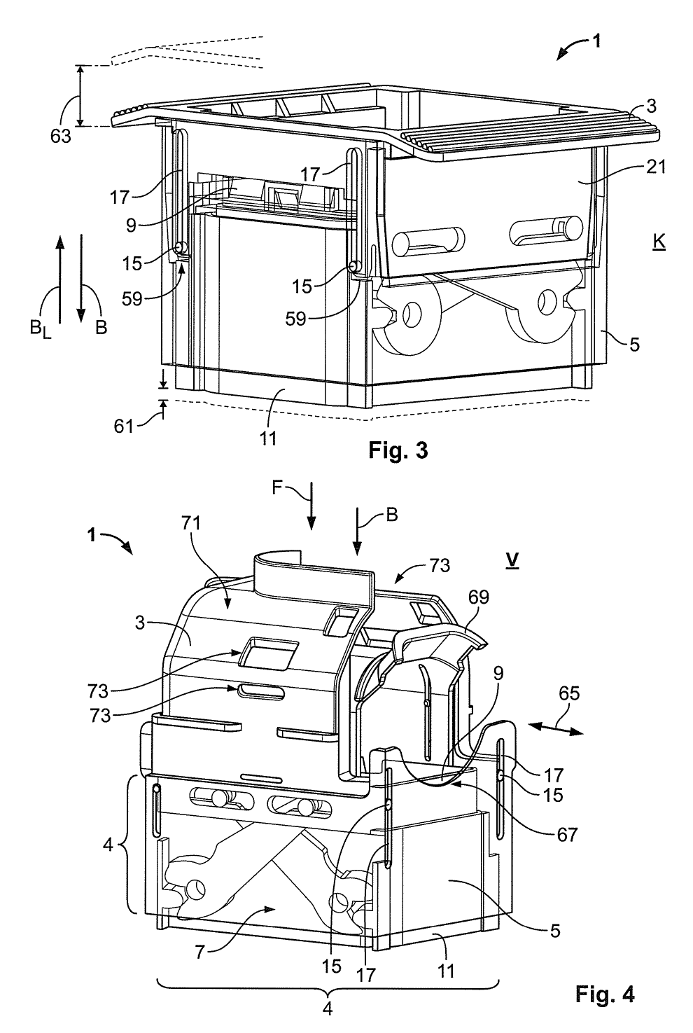

Now with reference to FIG. 2, the arrangement 1 is shown relative to the action mechanism pairs 7, 8 without any connector 9 and mating connector 11. The tilting levers 35, 35′ are constructed as flat members that extend parallel with the side wall 25. The lever arms 33, 33′ have a lever arm thicknesses 51, 51′ (in a direction S perpendicular relative to the side wall 25) whose sum is not greater than one of the head thicknesses 53, 53′. The lever arm thicknesses 51, 51′ are preferably of the same size and each corresponds to one half of a head thickness 53, 53′, the head thicknesses 53, 53′ also being of the same size. The shaft 6 extends between the side wall 25 and the connector receiving chamber 4 as a flat member in which the action mechanism pair 7 is arranged. Retention struts 55, 55′ extend through the connector receiving chamber 4 and secure the connector 9 in the housing 5 (see FIGS. 1 and 3).

The interaction of the arrangement 1 with a connector 9 and a mating connector 11 is explained below and the function thereof described: in order to prevent the slipping of an connector 9 counter to the actuation direction B.

The housing 5 may include retention ribs 55, 55′ that retain the connector 9 inside the housing 5. The connector 9 may alternatively be retained inter alia by means of retention clips, catch projections or similarly conventional securing members. The connector 9 may also be retained using catch elements, which prevent undesirable displacement of the connector 9 in an actuation direction B.

In order to connect a connector 9 to a mating connector 11, the mating connector 11 is inserted into the housing 5 counter to the actuation direction B. The arrangement 1 is located in the pre-contact position V. The mating connector 11 has output projections 57, 57′ which are constructed in such a manner that they fit between the drive teeth 47a, 47a′, 47b, 47b′. In this instance, the output projection 57 is received between the drive teeth 47a and 47b and the output projection 57′ is received between the drive teeth 47a′ and 47b′.

When the mating connector 11 is inserted into the housing 5, the drive teeth 47a and 47a′ act as stopping elements for the mating connector 11. The mating connector 11 is thereby retained in the pre-contact position V in a desired position, from which a further advance of the mating connector 11 in the direction towards the connector 9 is substantially carried out by the action mechanism pair 7.

In order to connect the connector 9 to the mating connector 11, an actuation force F is now applied to the actuator 3 along the actuation direction B and the actuator 3 is displaced in the actuation direction B. The displacement of the actuator 3 is transmitted to the tilting levers 35, 35′ using the sliding blocks 27, 27′ arranged in the slotted members 23, 23′ so that the lever arms 33, 33′ are lowered in an actuation direction B. The sliding blocks 27, 27′ move outwards in the slotted member directions N, N′. This movement of the tilting levers 35, 35′ leads to a rotation of the output heads 45, 45′ about the pivot members 37, 37′ so that the drive teeth 47b, 47b′ act as load arms on the output projections 57, 57′ and the mating connector 11 is displaced in the direction towards the connector 9.

In an exemplary embodiment, the lever arms 33, 33′ are longer than the drive teeth 47a, 47a′, 47b, 47b′ so that the actuation force F applied to the actuator 3 by the action mechanism pair 7 acts in an increased manner on the mating connector 11. The cross-wise arrangement of the tilting levers 35, 35′ may in this instance prevent tilting of the mating connector 11 with the connector 9. If, for example, the actuation force F acts more powerfully on the actuator 3 in a region located above the sliding block 27′, this will first lead to an actuation of the tilting lever 35′ and the mating connector 11 in the region around the output projection 57′ is displaced in the direction towards the connector 9. The non-uniform force distribution is thereby compensated for and tilting is prevented.

Now with FIG. 3, the arrangement 1 is shown in a contact position K between the connector 9 and the mating connector 11, at the end of the displacement process described above. The contact position K corresponds to an assembled state K between the connector 9 and then mating connector 11. The member 21 of the actuator 3 is completely inserted into the housing 5 and the guiding members 15 have reached contact ends 59 of the guiding slots 17. The contact ends 59 of the guiding slots 17 predetermine the end position for the actuator 3. In alternative embodiments, it is not necessary to introduce a member 21 of the actuator 3 completely into the housing 5. However, it is practical since in this manner a very compact form is obtained in the contact position K.

The mating connector 11 in the contact position K is connected to the connector 9 and introduced to the maximum extent into the housing 5 counter to the actuation direction B. The mating connector 11 is then located inside the connector receiving chamber 4. The connector 9 and mating connector 11 are then surrounded by the housing 5 transversely relative to the actuation direction B. The displacement path 61, by which the mating connector 11 has been displaced counter to the actuation direction B, is smaller than the actuation path 63, which the actuator 3 has travelled in the actuation direction B. The increase of the actuation force F on the mating connector 11 corresponds to the relationship of the actuation path 63 to the displacement path 61.

In order to release the mating connector 11 from the connector 9, the reverse procedure is carried out. The actuator 3 is moved in the actuation direction B_{L}, which is counter to the actuation direction B for connecting the connector 9 and mating connector 11, whereby the action mechanism pair 7 acts in a force-increasing manner on the mating connector 11 in the original actuation direction B and the mating connector 11 is pushed out of the housing. The drive teeth 47a, 47a′ of the tilting levers 35, 35′ then act as load arms on the output projections 57, 57′.

Now with reference to FIG. 4, another arrangement 1 according to the invention is shown in a pre-contact position V.

The arrangement in FIG. 4 includes an opening for laying of at least one wire (not shown) or cable along a cable laying direction 65. The housing 5 a wire recess 67 positioned about the height of the connector 9. The wire recess 67 delimits a space for laying wires in an actuation direction B. In order to guide wires or to limit the available space counter to the actuation direction B, the arrangement 1 has a covering element 69. The covering element 69 is arranged so as to be non-displaceable with respect to the housing 5. It may be connected directly to the housing 5 or be fitted to the connector 9. In addition to the above-mentioned guiding of wires, it further serves to protect the side of the connector 9 directed counter to the actuation direction B.

The actuator 3 is partially closed so that an actuation force F can be carried out on the housing surface 71. The housing surface 71 of the actuator 3 has access openings 73 to secure the arrangement 1 or to guide wires to the connector 9. In the latter case, the covering element 69 must have suitable openings in order to guide the wires there through. The action mechanism pair 7 corresponds to the action mechanism pair 7 described with reference to FIGS. 1 and 2.

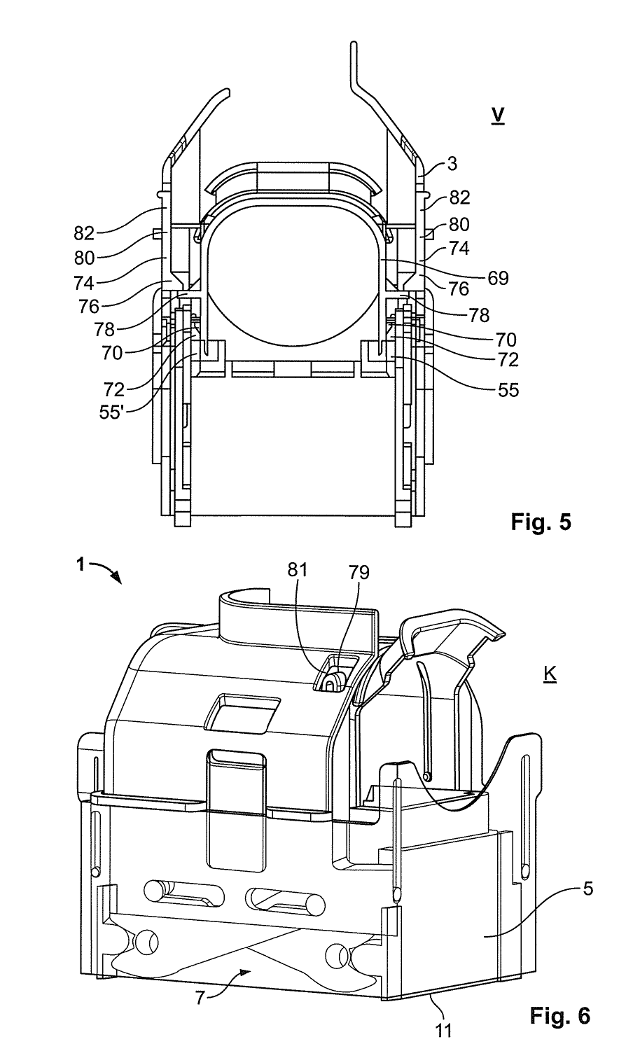

With reference to FIG. 5, the covering element 69 is retained by catch projections 70 in catch openings 72 of the retention struts 55, 55′. In order to prevent undesirable displacement of the actuator 3 from the pre-contact position V, the actuator 3 has two securing members 74. The securing members 74 have projections 76 which, in the pre-contact position V, strike securing ribs 78 of the covering element 69 in an actuation direction B. The securing members 74 are resiliently supported by pivot members 80 and can be redirected by the covering element 69 by pressure being applied to the actuation ends 82 opposite the projections 76 in the direction towards the actuator 3.

As shown in FIG. 6, an actuation force F applied to the arrangement along the actuation direction B displaces the actuator 3, whereby the action mechanism pair 7 of the mating connector 11 has moved inside the housing 5.

When the actuator 3 is displaced along the actuation direction B, the actuator 3 in addition to guiding by the guiding members 15 in the guiding slots 17 is further guided by the covering element 69. The covering element 69 has additional guiding slots 75, in which guiding members 77 of the actuator 3 are arranged in a protruding manner. The guiding slots 75 extend in the same manner as the guiding slots 17 that are parallel with the actuation direction B.

The covering element 69 has display elements 79 which are arranged along a side of the covering element 69. The actuator 3 includes control openings 81 along the housing surface 71, which are sized in such a manner that at least one display element 79 can protrude at least partially into a control opening 81. In the contact position K, the display elements 79 protrude into the control opening 81. Both optical and haptic verification of the completed connection is thereby possible.

In contrast to the prior art, a rotating actuator is not used so that the space for electrical cables is not unnecessarily limited. The actuator can be displaced in a linear manner and the mating connector is then moved by the action mechanism in the direction towards the connector. The actuation direction and the movement direction of the mating connector can be precisely opposed and parallel with each other. Using the action mechanism, the force which is applied to the actuator can be reinforced. The connector receiving chamber may serve to receive the connector and/or the mating connector. When the connector and mating connector are joined together, the mating connector can be moved into the connector receiving chamber by the output. The actuator which surrounds the connector receiving chamber may also at least partially surround an electrical cable which leads to the connector. An electrical cable may then be guided in particular through a cable receiving passageway in the actuator. The actuator may during the actuation in particular move parallel with a wire so that the actuator and wire cannot block each other.

Although exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. An arrangement comprising:
a housing;
an actuator positioned along a surface of the housing;
a connector receiving chamber surrounded by the housing and the actuator; and
an action mechanism having a drive connected to the actuator to move the actuator along the surface of the housing.

2. The arrangement according to claim 1, where in the actuator is positioned along an outside surface of the housing.

3. The arrangement according to claim 1, wherein the action mechanism is positioned outside the connector receiving chamber.

4. The arrangement according to claim 1, wherein the action mechanism includes a shaft extending along one side of the housing between the connector receiving chamber and a wall of the housing.

5. The arrangement according to claim 1, further comprising a second action mechanism positioned on an opposite side of the connector receiving chamber with respect to the action mechanism.

6. The arrangement according to claim 1, further comprising a pair of action mechanisms provided along one side the connector receiving chamber.

7. The arrangement according to claim 1, wherein the action mechanism includes a tilting lever connected to the housing and the actuator.

8. The arrangement according to claim 7, wherein the tilting lever includes a tooth arrangement at a proximal end thereof.

9. The arrangement according to claim 8, wherein the actuator includes a slotted member engaging a distal end of the tilting lever.

10. The arrangement according to claim 9, wherein the tilting lever is rotatably supported between the slotted member and the tooth arrangement.

11. The arrangement according to claim 1, further comprising a covering element positioned between the housing and the actuator.

12. The arrangement according to claim 11, wherein the covering element is non-displaceable relative to the housing.

13. The arrangement according to claim 1, further comprising a pair of action mechanisms positioned along a side of the connector receiving chamber and having a pair of tilting levers that intersect each other.

14. The arrangement according to claim 1, wherein the actuator includes a guiding member.

15. The arrangement according to claim 14, wherein the housing includes a guiding slot extending along a height of the housing.

16. The arrangement according to claim 15, wherein the guiding member is positioned in and guided by the guiding slot.

17. The arrangement according to claim 14, wherein the actuator includes a slotted member extending across a width f the actuator.

18. The arrangement according to claim 17, wherein the action mechanism includes a sliding block positioned in the slotted member.

19. The arrangement according to claim 18, wherein the slotted member includes an insertion opening by which the sliding block is guided.

20. The arrangement according to claim 19, wherein the sliding block includes a guiding groove receiving the slotted member.
